(19) United States
(12) Patent Application Publication
(10) Pub. No.: US 2019/0031950 A1
(43) Pub. Date: Jan. 31, 2019

(54) METHOD OF ENHANCING CONDUCTIVITY IN A SUBTERRANEAN FORMATION

(71) Applicant: Baker Hughes, a GE company, LLC, Houston, TX (US)

(72) Inventor: NAIMA BESTAOUI-SPURR, The Woodlands, TX (US)

(21) Appl. No.: 16/149,031

(22) Filed: Oct. 1, 2018

Related U.S. Application Data
(63) Continuation-in-part of application No. 15/360,696, filed on Nov. 23, 2016, now Pat. No. 10,087,365.
Application No. 15/360,696 is a continuation-in-part of application No. 14/066,893, filed on Oct. 30, 2013, now abandoned.

(51) Int. Cl. C09K 8/80; C09K 8/62; C09K 8/56; E21B 43/267

(52) U.S. Cl. CPC C09K 8/805; E21B 43/267; C09K 8/56; C09K 8/62

(57) ABSTRACT

The strength of a proppant or sand control particulate may be improved by coating the proppant to form a composite. The composite has enhanced compressive strength between about 60 to about 130 MPa and minimizes the spalling of fines at closure stresses in excess of 10,000 psi. Conductivity of fractures is further enhanced by forming a pack of the composites in the fracture.

This application is a continuation-in-part of U.S. application Ser. No. 15/360,696, filed on Nov. 23, 2016, which is a continuation-in-part of U.S. application Ser. No. 14/066,893, filed on Oct. 30, 2013, both of which incorporated herein by reference.

### TECHNICAL FIELD

The disclosure relates to a method of increasing conductivity of a fracture within a subterranean formation and a method of reducing the amount of fines generated during a hydraulic fracturing operation using a composite comprising a core and a coating covering at least a portion of the core. The coating imparts improved strength to the core. Further, the disclosure relates to a method of using the composite in a sand control operation such as gravel packing, frac pack treatments, etc.

### BACKGROUND OF THE DISCLOSURE

Hydraulic fracturing is a common stimulation technique used to enhance production of hydrocarbon fluids from subterranean formations. In a typical hydraulic fracturing treatment, a treatment fluid containing a solid proppant is injected into the formation at a pressure sufficiently high to cause the formation to fracture or cause enlargement of natural fractures in the reservoir. The viscosity of the fracturing fluid containing the proppant is typically increased by the presence of a gelling agent such as a polymer, which may be uncrosslinked or crosslinked, and/or a viscoelastic surfactant. The proppant is deposited in the fracture, where it remains until after the treatment is completed. During the treatment, the proppant holds the fracture open and create a porous and permeable bed. The bed enhances the ability of fluids to migrate from the formation to the wellbore penetrating the formation through the fracture. Since productivity is dependent on the ability of the fracture to conduct fluids from the formation to the wellbore, fracture conductivity is an important parameter in determining the degree of success of a hydraulic fracturing treatment.

Choice of proppant is further often critical to the success of the stimulation operation. If the proppant granules cannot withstand the reservoir closure stress imposed by the formation, the granules are compressed together in such a way that they crush, and small particles of reservoir “fines” are generated from the proppant and/or reservoir matrix. This often leads to significant proppant pack conductivity damage and associated reduction in fracture conductivity. In some cases, production of fines may be exacerbated during production/workover operations when a well is shut-in and then re-opened. This phenomenon is known as “stress cycling” and is believed to result from increased differential pressure and closure stress that occurs during fluid production following shut-in. Production of fines is highly undesirable since fines reduce reservoir permeability by plugging pore throats in the reservoir.

Production of particulate solids with subterranean formation fluids is also a common problem. The source of these particulate solids may be unconsolidated material from the formation, proppant from a fracturing treatment and/or fines generated from crushed fracture proppant, as mentioned above. Production of solid proppant material is commonly known as “proppant flowback.” In addition to causing increased wear on downhole and surface production equipment, the presence of particulate materials in production fluids often leads to significant expense and production downtime associated with removing these materials from wellbores and/or production equipment. Accumulation of these materials in a wellbore may also restrict or even prevent fluid production. In addition, loss of proppant due to proppant flowback may also reduce conductivity of a fracture pack.

Due to its low cost and availability, silica (SiO₂) sand is typically used as proppant in fracturing operations as well as the particulate in sand control operations. The quality of the properties of sand vary depending on its origin. For instance, white sand, from the northern great lake regions (primarily Minnesota and Wisconsin) is monocrystalline, made of single quartz crystals that offer superior strength properties compared to other sands. Brown sand, such as Brady sand from Texas, is polycrystalline; each grain being composed of multiple crystals bonded together. The existence of cleavage planes within each grain results in greater crush and reduced properties of the proppant (or sand control particulate). Typically, untreated sand is not capable of withstanding closure stresses in excess of 6,000 psi. Such restrictions limit sand for use as a proppant or sand control particulate in shallow reservoirs. Stronger proppants and sand control particulates are needed for use in reservoirs having closure stresses in excess of 6,000 psi. Resin-coated sand is known to generate fewer fines up to closure stresses of about 8,000 psi. Fracture conductivity would be enhanced in deeper completions by use of proppants and sand control particulates stronger than resin-coated sands. While ceramic material have been known to provide better conductivity for formation closures of over 12,000 psi, such materials are expensive. Alternatives have therefore been sought for enhancing conductivity in formations having closure stresses up to 12,000 psi while minimizing spalling of formation fines.

It should be understood that the above-described discussion is provided for illustrative purposes only and is not intended to limit the scope or subject matter of the claims set forth herein. Thus, none of the claims should be limited by the above discussion or construed to address, include or exclude each or any of the above-cited features or disadvantages merely because of the mention thereof herein.

### SUMMARY OF THE DISCLOSURE

In an embodiment, a method of increasing the conductivity of a fracture in a subterranean formation using a composite is provided. The composite is composed of a core and a coating at least partially covering the core. The core may be sand, ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles or a combination thereof. The coating may be selected from aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK) or a combination thereof. A fracturing fluid containing particulates of the composite is introduced into the fracture within the formation. The particulates form a matrix or pack of composites having voids in the fracture.

In another embodiment, a method of fracturing a subterranean formation is provided. In this embodiment, a proppant comprising a composite is pumped into the well, at a pressure sufficient to enlarge or create a fracture, the composite comprising a core having a coating at least partially covering the core. The core may be sand, ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles or a combination thereof. The coating may be an aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK) or a combination thereof.

In another embodiment, a sand control operation on a subterranean formation is provided. In this embodiment, a slurry of a composite and a carrier fluid is pumped into the well bore penetrating the formation; the composite having a core with a coating at least partially covering the core. The core may be sand, ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles or a combination thereof. The coating may be an aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK) or a combination thereof. The composite is placed adjacent the formation to form a fluid-permeable pack capable of reducing or substantially preventing the passage of formation particles from the formation while allowing passage of formation fluids from the formation into the wellbore.

In another embodiment, a method of reducing the amount of fines generated during a hydraulic fracturing operation or a sand control operation in a subterranean formation is provided. In this embodiment, a proppant or sand control particulate (composite) is pumped into the well, the composite having a core and a coating at least partially covering the core. The core may be sand, ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles or a combination thereof. The coating may be an aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK) or a combination thereof. The amount of fines generated during pumping of the proppant or sand control particulate into the well is less than the amount of fines generated during pumping of the pristine proppant or sand control particulate not containing the coating.

In another embodiment of the disclosure, a composite is provided comprising a core selected from white sand, brown sand, ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles, and combinations thereof. The core is covered at least partially with a coating which may be selected from aluminosilicate, magnesium phosphate, aluminum phosphate, zirconium aluminum phosphate, zirconium phosphate, zirconium phosphonate, polymer cements, high performance polymer coating such as polyamide imide and polyether ether ketones (PEEK) or a combination thereof.

In a further embodiment, there is provided a method of preparing a strengthened proppant or sand control particulate wherein an alkali metal hydroxide and silica (or sodium silicate) and an aluminosilicate binder are mixed in water to form an aqueous solution. A core of the proppant or sand control particulate is then coated with the aqueous solution. During the coating, a reaction product is formed on the proppant or sand control core comprising polymerized aluminosilicate.

In another embodiment, sodium silicate is added to the alkali metal hydroxide/silica/alkali metal hydroxide/aluminosilicate binder or to the sodium silicate/alkali metal hydroxide/aluminosilicate binder as it is being applied onto the surface of the proppant or sand control particulate.

In a non-limiting embodiment a method of preparing a strengthened proppant or sand control particulate is provided wherein there is first mixed (a) a compound selected from an alkali metal phosphate, phosphoric acid, ammonium phosphate, ammonium di-hydrogen phosphate or a combination thereof, and (b) a binder in water to form an aqueous solution. The binder is selected from an alkaline earth metal hydroxide, an alkaline earth metal oxide, a metal oxide, a metal hydroxide, an aluminosilicate or a combination thereof. The method additionally includes at least partially coating a proppant or sand control particulate core with the aqueous solution, and then exposing the aqueous solution-coated proppant or sand control particulate core to a temperature to polymerize the (a) compound and (b) binder to form a coating where the coating includes, but is not necessarily restricted to, magnesium phosphate, aluminosilicate, calcium phosphate, aluminum phosphate, zirconium aluminum phosphate, zirconium phosphate, zirconium phosphonate, magnesium potassium phosphate, potassium aluminum phosphate, alkali metal transition metal phosphates, carbide materials, tungsten carbide, cements, polymer cements, polyamide-imides, polyether ether ketones (PEEK) or a combination thereof, to give the strengthened proppant or sand control particulate.

### BRIEF DESCRIPTION OF THE DRAWINGS

The following figures are part of the present specification, included to demonstrate certain aspects of various embodiments of this disclosure and referenced in the detailed description herein:

FIG. 1 is a schematic cross-section illustration of a coated proppant as described herein;

FIG. 2 is a chart of compressive strength for various coatings compositions in accordance with the methods described herein and as compared to a geopolymer aluminosilicate.

FIG. 3A is a microphotograph of white sand proppant with a 5 wt % coating of an alkali activated aluminosilicate;

FIG. 3B is a microphotograph of the white sand proppant used to form the coated proppant shown in FIG. 3A;

FIG. 4A is a scanning electron microscopy (SEM) image and FIGS. 4B-4D are electron back scattering images (using a scanning electron microscope) of the coated white sand proppants of FIG. 3 at 50× magnification;

FIG. 5A is a SEM image and FIGS. 5B-5D are images using a scanning electron microscope of the coated white sand proppants of FIG. 3 at 80× magnification;

FIG. 6A is a microphotograph of brown sand proppant with a 8 wt % coating of an alkali activated aluminosilicate;

FIG. 6B is a microphotograph of the brown sand proppant used to form the coated proppant in FIG. 6A;

FIG. 7 is a microphotograph of brown sand proppant with a 15 wt % coating of an alkali activated aluminosilicate;

FIG. 8 is a graph illustrating the wt % generated fines as a function of closure stress of geopolymer-coated sand compared to some conventional proppants;

FIG. 9 shows the effect of coating thickness of the composite on crush resistance.

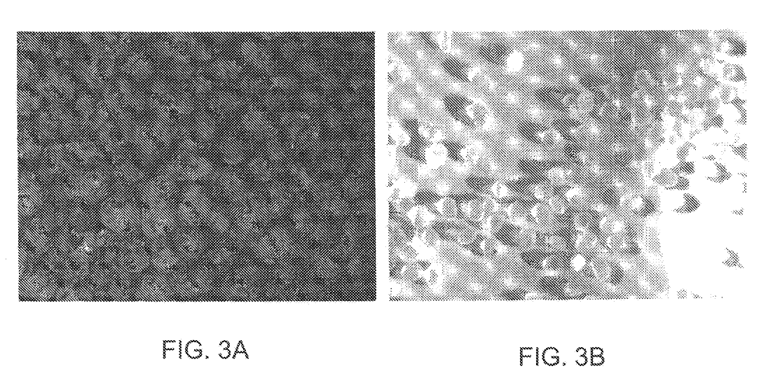

It will be appreciated that FIG. 1 is a schematic illustration, and that it is not necessarily to scale, and that certain proportions and features may be exaggerated for clarity. For instance, the proppant shown in FIG. 1 is illustrated to be perfectly spherical, whereas the microphotographs of FIGS. 3A-7 show that the proppants are actually only approximately spherical.

### DETAILED DESCRIPTION OF THE PREFERRED EMBODIMENTS

Characteristics and advantages of the present disclosure and additional features and benefits will be readily apparent to those skilled in the art upon consideration of the following detailed description of exemplary embodiments of the present disclosure and referring to the accompanying figures. It should be understood that the description herein and appended figures, being of example embodiments, are not intended to limit the claims of this patent or any patent or patent application claiming priority hereto.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, the term “substantially” in reference to a given parameter, property, or condition means and includes to a degree that one of ordinary skill in the art would understand that the given parameter, property, or condition is met with a degree of variance. By way of example, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

Further, reference herein to components and aspects in a singular tense or to the suffix(es) does not necessarily limit the present disclosure to only one such component or aspect, but should be interpreted generally to mean one or more, as may be suitable and desirable in each particular instance.

All ranges disclosed herein are inclusive of the endpoints. A numerical range having a lower endpoint and an upper endpoint shall further encompass any number and any range falling within the lower endpoint and the upper endpoint. For example, every range of values in the form “from a to b” or “from about a to about b” or “from about a to b,” “from approximately a to b,” “between about a and about b,” and any similar expressions, where “a” and “b” represent numerical values of degree or measurement is to be understood to set forth every number and range encompassed within the broader range of values and inclusive of the endpoints.

All references are incorporated herein by reference.

The disclosure relates to proppant and sand control particulates having a coating which at least partially covers the proppant or sand control particulate core; the coating imparts improved mechanical properties to the proppant or sand control particulate. In a preferred embodiment, the disclosure relates to use of geopolymers as the coating. As referenced herein, the term “geopolymer” shall refer to an inorganic polymer formed by reacting an alkaline solution and an aluminosilicate source.

The proppant or sand control particulate of the composite demonstrates much greater strength than the uncoated proppant or sand control particulate. It will be appreciated that “a coating at least partially covering the proppant or sand control particulate cores” may be defined as the majority (over 50 wt %) of the proppant or sand control particulates have at least some coating thereon even if 100 wt % of the proppant or sand control particulates are not completely covered. Alternatively, “a coating at least partially covering the proppant or sand control particulate cores” may be defined as at least the majority (over 50 wt %) of the proppant or sand control particulates are completely covered with the coating. In another non-limiting embodiment, both of these definitions may be used simultaneously.

The proppant or sand control particulate is the core of the composite; the aluminosilicate or phosphate ceramic covers at least a portion of the surface of the core.

In a preferred embodiment, aluminosilicates and chemically bonded phosphate ceramics (CBPCs) form the coating which covers (at least partially) the core of the proppant or sand control particulate. The inorganic polymer may be formed onto the proppant core or sand control particulate in an exothermic polymerization reaction between the compound and binder solution forming a solid polymer at room temperature or initiated under mild heat causing the molecules to poly-condense or polymerize. In a preferred embodiment, the coating is made through poly-condensation of hydroxyl groups or polymerization reaction triggered at mild temperatures.

A suitable temperature range to initiate the polymerization of the coating may range from about 32° F. to about 575° F.; in another non-restrictive embodiment from about 65° F. to about 575° F.; alternatively from about 140° F. to about 400° F.

A homogeneous well distributed coating typically surrounds the proppant or sand control particulate core. The inorganic network surrounding the proppant or sand control particulate core with its amorphous three dimensional structure significantly increases the compressive strength of the proppant or sand control particulate.

In an embodiment, the composite may be prepared by applying onto the proppant core or sand control particulate a sol containing a compound selected from the group consisting of an alkali metal hydroxide/silica, alkali silicate, alkali metal phosphate, a phosphoric acid, ammonium phosphate and combinations thereof and a binder solution made of an alkaline earth metal hydroxide, an alkaline earth metal oxide, a metal oxide, a metal hydroxide, an aluminosilicate, and combinations thereof, in water which results in a very strong, rigid network.

In some cases, it may be desirable to pre-heat the compound and/or binder solution prior to applying the same onto the core. In other instances, it may be desirable to heat the core prior to applying the compound and/or binder solution onto the surface of the core. In such cases, the temperature of the core may be between 0 to about 300° C. when the coating is applied.

In another embodiment, it is desirable to etch the surface of the proppant or sand control particulate core prior to applying the sol to the surface. Typically, etching can be performed by mildly scrubbing the surface of the core with an alkaline hydroxide, such as sodium hydroxide or potassium hydroxide. Such scrubbing generates hydroxyl groups on the surface of the core. Reaction of the surface of the core with the sol is thereby enhanced.

By dramatically increasing the strength of the proppant or sand control particulate, use of the proppant or sand control particulate (in the form of the composite) may be extended to formation closure stresses of at least about 5000 psi (34 MPa), alternatively at least to about 6,000 psi (41.37 MPa), alternatively at least to about 10,000 psi (69 MPa) and in another non-limiting embodiment to about 12,000 psi (83 MPa), alternatively at least to about 16,000 psi (110.32 MPa) and even up to 18,900 psi (130 MPa). In one non-limiting embodiment, the compressive strength ranges from about 35 to about 130 MPa, alternatively from about 50 to about 100 MPa, and in another non-restrictive embodiment from about 60 to about 83 MPa. At such closure stresses, the generation of fines is decreased.

The apparent density of the composite may be less than the apparent density of the core. Apparent density as referenced herein may be determined using the API standard API-RP-19C.

In one non-limiting embodiment, the core may have an apparent density greater than or equal to 2.5 and alternatively greater than or equal to 2.65 g/cm³. For example, sand has an apparent density of approximately 2.65 g/cm³. The apparent density of a composite having a core of sand is typically between about 2.3 to about 2.63 g/cm³, alternatively from between about 2.55 to about 2.6 g/cm³; in another non-restrictive version from about 2 to about 2.61 g/cm³. In another non-limiting embodiment, the apparent density of composites chemically bonded with aluminosilicates or CBPCs and other materials described herein ranges from about 1.8 to 2.5 g/cm³.

In another non-limiting embodiment, the proppant or sand control particulate core may be a relatively lightweight or substantially neutrally buoyant particulate material or a mixture thereof. Such materials may be chipped, ground, crushed, or otherwise processed By “relatively lightweight” it is meant that the solid particulate has an apparent specific gravity (ASG) which is less than or equal to 2.45, including those ultra lightweight materials having an ASG less than or equal to 2.25, alternatively less than or equal to 2.0, in a different non-limiting embodiment less than or equal to 1.75, in another non-limiting embodiment less than or equal to 1.5, and in another non-restrictive version less than or equal to 1.25 and often less than or equal to 1.05.

Suitable relatively lightweight solid particulates are those disclosed in U.S. Pat. Nos. 6,364,018; 6,330,916; and 6,059,034, all of which are herein incorporated by reference.

Naturally occurring solid particulates include, but are not necessarily limited to, nut shells such as walnut, coconut, pecan, almond, ivory nut, brazil nut, and the like; seed shells of fruits such as plum, olive, peach, cherry, apricot, and the like; seed shells of other plants such as maize (e.g., corn cobs or corn kernels); wood materials such as those derived from oak, hickory, walnut, poplar, mahogany, and the like. Such materials are particles may be formed by crushing, grinding, cutting, chipping, and the like.

Other solid particulates for use herein include beads or pellets of nylon, polystyrene, polystyrene divinyl benzene or polyethylene terephthalate such as those set forth in U.S. Pat. No. 7,931,087, also incorporated herein by reference.

Exemplary cores may include white sand, brown sand, ceramic beads, glass beads, bauxite grains, sintered bauxite, sized calcium carbonate, walnut shell fragments, aluminum pellets, silica, nylon pellets, nut shells, gravel, resinous particles, alumina, minerals, polymeric particles, and combinations thereof.

Examples of ceramics include, but are not necessarily limited to, oxide-based ceramics, nitride-based ceramics, carbide-based ceramics, boride-based ceramics, silicide-based ceramics, or a combination thereof. In a non-limiting embodiment, the oxide-based ceramic may include, but is not necessarily limited to, silica (SiO₂), titania (TiO₂), aluminum oxide, boron oxide, potassium oxide, zirconium oxide, magnesium oxide, calcium oxide, lithium oxide, phosphorous oxide, lead zirconate titanate and/or baritum titanate, or a combination thereof. The oxide-based ceramic, nitride-based ceramic, carbide-based ceramic, boride-based ceramic, or silicide-based ceramic may contain a nonmetal (e.g., oxygen, nitrogen, boron, carbon, or silicon, and the like), metal (e.g., aluminum, lead, bismuth, and the like), transition metal (e.g., niobium, tungsten, titanium, zirconium, hafnium, yttrium, and the like), alkali metal (e.g., lithium, potassium, and the like), alkaline earth metal (e.g., calcium, magnesium, strontium, and the like), rare earth (e.g., lanthanum, cerium, and the like), or halogen (e.g., fluorine, chlorine, and the like). Exemplary ceramics include, but are not necessarily limited to, zirconia, stabilized zirconia, mullite, zirconia toughened alumina, spinel, aluminosilicates (e.g., mullite, cordierite), perovskite, silicon carbide, silicon nitride, titanium carbide, titanium nitride, aluminum carbide, aluminum nitride, zirconium carbide, zirconium nitride, iron carbide, aluminum oxynitride, silicon aluminum oxynitride, aluminum titanate, tungsten carbide, tungsten nitride, steatite, and the like, or a combination thereof.

Examples of suitable sands for the proppant or sand control particulate core include, but are not limited to, Arizona sand, Wisconsin sand, Badger sand, Brady sand, and Ottawa sand. In a non-limiting embodiment, the solid particulate may be made of a mineral such as bauxite which is sintered to obtain a hard material. In another non-restrictive embodiment, the bauxite or sintered bauxite has a relatively high permeability such as the bauxite material disclosed in U.S. Pat. No. 4,713,203, the content of which is incorporated by reference herein in its entirety.

Where the coating is applied to relatively lightweight proppant or sand control particulates, strength of the proppant or sand control particulate is enhanced while low apparent density is maintained (reduced).

The coating will also increase the temperature tolerance of the polymer proppant or sand control particulate core. By “tolerance” is meant that the composite maintains its structural integrity, that is, it does not break down into smaller fragments up to at least this temperature, or when it contacts chemicals up to at least this temperature.

The coating may include, but not necessarily be limited to, aluminosilicate, magnesium phosphate, calcium phosphate, aluminum phosphate, zirconium aluminum phosphate, zirconium phosphate, zirconium phosphonate, magnesium potassium phosphate, potassium aluminum phosphate, alkali metal transition metal phosphate, carbide materials such as tungsten carbide, cements, polymer cements, high performance polymer coatings such as polyamide-imide and polyether ether ketones (PEEK), and combinations thereof. “High performance polymers” means that they have high temperature tolerance (more than 300° F.) and are chemically resistant.

The amount of the coating on the proppant or sand control particulate core ranges from about 0.5 wt % to about 30 wt % or higher; alternatively from about 0.5 wt % to about 15 wt %; and alternatively from about 1 wt. % to about 8 wt. % by weight of the core. Suitable amounts include, but are not necessarily limited to, about 2 wt %, about 4 wt %, about 5 wt %, about 8 wt %, and about 15 wt %, any of which may serve as a suitable lower or upper threshold of a proportion range.

In an embodiment, the composite withstands a closure stress up to about 8,000 psi when the coating ranges from about 1 to about 9 wt. percent of the weight of the core, up to about 10,000 psi when the coating ranges from about 1 to about 15 wt. percent of the weight of the core and alternatively, up to about 12,000 psi when the coating ranges from about 3 to about 20 wt. percent of the weight of the core.

The thickness of the coating may range from about 2 independently to about 120 microns, alternatively from about 50 independently to about 80 microns, over a relatively wide range, in another non-limiting embodiment. Thickness of the coating has been shown to significantly increase the strength and crush resistance of the proppant or sand particulate core. As stated herein, the coating protects the particle from crushing, helps resist embedment, and prevents the liberation of fines.

Exemplary cores may include sand, including white sand and brown sand, ceramic beads, glass beads, bauxite grains, sintered bauxite, sized calcium carbonate, walnut shell fragments, aluminum pellets, silica, nylon pellets, nut shells, gravel, resinous particles, alumina, minerals, polymeric particles, and combinations thereof.

Examples of ceramics include, but are not necessarily limited to, oxide-based ceramics, nitride-based ceramics, carbide-based ceramics, boride-based ceramics, silicide-based ceramics, or a combination thereof. In a non-limiting embodiment, the oxide-based ceramic may include, but is not necessarily limited to, silica (SiO₂), titania (TiO₂), aluminum oxide, boron oxide, potassium oxide, zirconium oxide, magnesium oxide, calcium oxide, lithium oxide, phosphorous oxide, lead zirconate titanate and/or barium titanate, or a combination thereof. The oxide-based ceramic, nitride-based ceramic, carbide-based ceramic, boride-based ceramic, or silicide-based ceramic may contain a nonmetal (e.g., oxygen, nitrogen, boron, carbon, or silicon, and the like), metal (e.g., aluminum, lead, bismuth, and the like), transition metal (e.g., niobium, tungsten, titanium, zirconium, hafnium, yttrium, and the like), alkali metal (e.g., lithium, potassium, and the like), alkaline earth metal (e.g., calcium, magnesium, strontium, and the like), rare earth (e.g., lanthanum, cerium, and the like), or halogen (e.g., fluorine, chlorine, and the like). Exemplary ceramics include, but are not necessarily limited to, zirconia, stabilized zirconia, mullite, zirconia toughened alumina, spinel, aluminosilicates (e.g., mullite, cordierite), perovskite, silicon carbide, silicon nitride, titanium carbide, titanium nitride, aluminum carbide, aluminum nitride, zirconium carbide, zirconium nitride, iron carbide, aluminum oxynitride, silicon aluminum oxynitride, aluminum titanate, tungsten carbide, tungsten nitride, steatite, and the like, or a combination thereof.

Examples of suitable sands for the proppant or sand control particulate core include, but are not limited to, Arizona sand, Wisconsin sand, Badger sand, Brady sand, and Ottawa sand. In a non-limiting embodiment, the solid particulate may be made of a mineral such as bauxite which is sintered to obtain a hard material. In another non-restrictive embodiment, the bauxite or sintered bauxite has a relatively high permeability such as the bauxite material disclosed in U.S. Pat. No. 4,713,203, the content of which is incorporated by reference herein in its entirety.

In an embodiment, the strengthened proppant or sand control particulate may be composed of a core selected from the group consisting of sand, including white sand and brown sand, ceramic beads, glass beads, bauxite grains, sintered bauxite, sized calcium carbonate, walnut shell fragments, aluminum pellets, silica, nylon pellets, nut shells, gravel, resinous particles, alumina, minerals, polymeric particles, and combinations thereof, and a coating at least partially covering the proppant core, where the coating is selected from the group consisting of aluminosilicate, magnesium phosphate, calcium phosphate, aluminum phosphate, zirconium aluminum phosphate, zirconium phosphate, zirconium phosphonate, magnesium potassium phosphate, potassium aluminum phosphate, alkali metal phosphates, carbide materials such as tungsten carbide, cements, polymer cements, high performance polymer coatings such as polyamide-imide and polyether ether ketones (PEEK), and combinations thereof.

In an embodiment, the strengthened proppant or sand control particulate may be prepared by mixing together (a) a compound selected from the group consisting of an alkali metal phosphate, phosphoric acid, ammonium phosphate, ammonium di-hydrogen phosphate, and combinations thereof, and (b) a binder selected from the group consisting of an alkaline earth metal hydroxide, an alkaline earth metal oxide, a metal oxide, a metal hydroxide, an aluminosilicate, and combinations thereof in water to form an aqueous solution; at least partially coating a plurality of proppant cores with the aqueous solution; and exposing the aqueous solution-coated proppant cores to a temperature to polymerize the (a) compound selected from the group consisting of an alkali metal phosphate, a phosphoric acid, ammonium phosphate, and combinations thereof and (b) binder selected from the group consisting of a metal oxide, a metal hydroxide, an alkaline earth metal hydroxide, an alkaline earth metal oxide, an aluminosilicate, and combinations thereof to form a coating where the coating is selected from the group consisting of magnesium phosphate, calcium phosphate, aluminum phosphate, zirconium aluminum phosphate, zirconium phosphate, zirconium phosphonate, magnesium potassium phosphate, potassium aluminum phosphate, alkali metal transition metal phosphates, carbide materials, tungsten carbide, cements, polymer cements, polyamide-imides, polyether ether ketones (PEEK), and combinations thereof, to give the strengthened proppant.

In another embodiment, a strengthened proppant may be prepared by mixing together an alkali phosphate or phosphoric acid to form an aqueous/gelatinous solution and a metal oxide in the presence of water. The metal oxide is sparsely soluble in water and will react with the alkali phosphate or phosphoric acid to form an aqueous/gelatinous solution. The solution is then coated onto the core. The metal phosphate may then be polymerized either at room temperature or by exposing the solution-coated core to heat in an oven or another heat source, such as a heat gun.

In a preferred embodiment, phosphate ceramic binders may be prepared by the reaction of a phosphate solution including, but not limited to KH₂PO₄ and a binder source through a sol-gel exothermic reaction. Chemically bonded phosphate ceramics are typically generated by an acid/base reaction of an acidified phosphate or phosphoric acid and a sparsely soluble metal oxide. They optionally contain fillers that actively participate with the components of the reaction. Such fillers include, but are not necessarily limited to, fly ash and wollastonite and the like. The ratio of filler to reaction components (acidic solution and binder) can vary between about 1 independently to about 80 wt % of the total mass of solid material used in the reaction; alternatively between about 5 independently to about 70 wt %. In an embodiment, the acidic solution may be acidic because of the presence of an alkali metal phosphate, phosphoric acid or ammonium phosphate, ammonium di-hydrogen phosphate or the like. The sparsely soluble oxide can be any alkaline earth metal oxide, alkaline earth metal hydroxide, a metal hydroxide, a metal oxide or an aluminosilicate and the like. In an embodiment, the metal of the oxide or hydroxide is aluminum, silicon, zirconium, titanium, niobium, magnesium, manganese, calcium or a combination thereof. Sparsely soluble means that the oxide has low solubility in water or solubilizes very slowly in water. The reaction occurs between the acidic solution and the solubilized binder until the majority of the components (acidic solution and binder) are spent and transformed to the chemically bonded phosphate ceramics.

Optionally boric acid and/or borax may be used as a retarder to slow down the reaction.

There may also be provided coated proppants prepared by a method of mixing together a phosphoric acid or an alkali phosphate, a filler consisting essentially of an aluminosilicate such as fly ash or wollastonite, and a metal oxide in the presence of water to form an aqueous gelatinous solution, and heating the aqueous solution-coated proppant cores to polymerize the compound and the binder.

In a preferred embodiment, the composite is a strengthened proppant or sand control particulate having an aluminosilicate (geopolymer) coated onto at least a portion of the proppant or sand control core.

When the coating is a geopolymer, an alkaline solution is required to cause the geopolymerization reaction. This could be the monovalent alkali metal hydroxide including potassium hydroxide, sodium hydroxide, and the like. If a divalent alkali metal hydroxide is used, the solubility will decrease and some amount of a monovalent alkali metal hydroxide may be necessary or helpful in order to initiate the reaction combinations thereof.

In an embodiment, the composite may be prepared by first preparing an aqueous sol of a mixture of an alkali activated silica, alkali oxide, alkali hydroxide (sodium oxide, potassium oxide, sodium hydroxide or potassium hydroxide being preferred) and aluminosilicate binder. The sol is then applied onto the proppant or sand control core. The sol may then be subjected to low temperature heating to initiate polymerization through a sol-gel exothermic reaction to render the aluminosilicate onto the proppant core or sand control particulate.

In a preferred embodiment where the coating is a geopolymer formed from an alkali metal hydroxide and silica (or an alkali silicate) and aluminosilicate binder, such coatings have an amorphous, three-dimensional non-crystalline structure similar to that of an aluminosilicate glass.

In a preferred embodiment, the mole ratio of SiO₂/Al₂O₃ in forming the geopolymer aluminosilicate coating and the mole ratio between the acidic solution (sometimes termed “the compound”) and the binder in forming the CBPC from about 0.1:1 independently to about 30:1; alternatively from about 1:1 independently to about 6:1. In another non-restrictive version, the mole ratio of SiO₂ to alkali metal hydroxide or alkali metal oxide (e.g. Na₂O or K₂O) in forming the geopolymer ranges from about 0.1:1 to about 6:1; alternatively, from about 0.67:1 to about 2:1. Suitable ratios include, but are not necessarily limited to about 1.3:1 and about 1.52:1; either of which may be suitable alternative lower or upper thresholds of a range.

In an embodiment, the coating process includes coating the heated core in a reactor and then adding the binder while exposing the sample to a heat gun or other source of heat. The resulting composite may or not then be put in an oven for about three hours to finish the polymerization process. Silicon and aluminum hydroxide may polymerize to form rigid chains or nets of oxygen bonded tetrahedra.

In some instances, it is desirable to pre-heat the proppant or sand control particulate core prior to introducing the coating components into the mixer. When desired, the proppant or sand control particulates may be pre-heated to a temperature between from about 100° F. to about 350° F.

In a preferred embodiment, mixing vessel, into which the coating is applied onto the proppant or sand control particulate core, is a bowl-shaped mixer having a curved bottom. The bowl is at a 45 degree angle from the point of introduction of the components which form the composite. Such reactors enhance the formation of a homogeneous coating onto the surface of the proppant or sand control particulate core.

A suitable temperature range to further complete or cure the polymerization of the coating may range from about 65° F. to about 575° F.; alternatively from about 77° F. to about 400° F. In some instances the binder is not completely solubilized and some of the particles that did not solubilize become encapsulated in the ceramics acting as a reinforcing agent increasing the strength of the material. These inorganic polymers are considered “green” or environmentally advantageous, because they are synthesized from natural resources and their chemistry does not adversely affect the environment.

With a geopolymer, an alkaline solution is required to cause the geopolymerization reaction. This could be the monovalent alkali metal hydroxide including potassium hydroxide, sodium hydroxide, and the like. If a divalent alkali metal hydroxide is used, the solubility will decrease and some amount of a monovalent alkali metal hydroxide may be necessary or helpful in order to initiate the reaction combinations thereof.

The size of the composite may be any size suitable for use in a fracturing treatment of a subterranean formation or a sand control operation. The optimal size of the composite may be dependent on in situ closure stress. In an embodiment, the composites may have a particle size of less than about 1 micron, less than about 0.5 micron, or less than about 0.1 micron. In an embodiment, the composites may have a particle size of about 10 nanometers to about 500 nanometers, about 20 nanometers to about 100 nanometers or about 20 nanometers to about 40 nanometers. As used herein, “size” refers to the largest linear dimension, e.g., a diameter in a spherical particle.

Suitable shapes for the composites include, but are not necessarily limited to, beaded, cubic, bar-shaped, cylindrical, rod-shaped or a mixture thereof. Shapes of the proppant or sand control particulates may vary, but in one embodiment may be utilized in shapes having maximum length-based aspect ratio values, in one exemplary embodiment having a maximum length-based aspect ratio of less than or equal to about 25, alternatively of less than or equal to about 20, alternatively of less than or equal to about 7, and further alternatively of less than or equal to about 5. In yet another exemplary embodiment, shapes of such composites may have maximum length-based aspect ratio values of from about 1 to about 25, alternatively from about 1 to about 20, alternatively from about 1 to about 7, and further alternatively from about 1 to about 5. In yet another exemplary embodiment, such composites may be utilized in which the average maximum length-based aspect ratio of particles present in a sample or mixture containing only such particles ranges from about 1 to about 25, alternatively from about 1 to about 20, alternatively from about 2 to about 15, alternatively from about 2 to about 9, alternatively from about 4 to about 8, alternatively from about 5 to about 7, and further alternatively is about 7.

In one embodiment, the composite used may have a beaded shape or spherical shape and a size of from about 4 mesh (to about 300 mesh, alternatively from about 8 mesh to about 140 mesh, alternatively from about 12 mesh to about 60 mesh, alternatively from about 16 mesh to about 40 mesh, and alternatively about 20/40 mesh. Thus, in one embodiment, the composite may range in size from about 10 or 18 mesh to about 150 mesh; alternatively their size will be from about 20 to about 70 mesh, alternatively from about 30 to about 40 mesh, and alternatively about 30 mesh. However, sizes greater than about 10 mesh and less than about 140 mesh are possible as well.

The composite is preferably a sphere having a Krumbein sphericity (API-RP-19C) of at least about 0.5, alternatively at least about 0.6; and a roundness (Sloss Chart) of at least about 0.4, alternatively at least about 0.6.

The physical properties of the composite are largely determined by the ratio of the compounds and binder(s). By varying this ratio, the material may be made rigid, suitable for use as a concrete, cement, or waste encapsulating medium, or more flexible for use as an adhesive, sealant or as an impregnating resin. The coating process is similar to that of resin coated sand and is accomplished by coating heated core in a mixer, such as a rotary mixer, with the solution and including the compound and the binder when exposing the sample to a heat gun or other heat source for less than about ten minutes to trigger polymerization.

In an embodiment, the surface of the composite may be modified to render the composite hydrophobic or oleophobic.

For instance, the composite may be rendered hydrophobic by modifying the surface of the composites with an aliphatic group, an oil or a fat. Surface modified means that the aliphatic groups are bonded to the surface of the composite or physically associated with the surface. In an embodiment, the aliphatic groups are bonded to the surface of the composite via a functional group, for example a carboxylate group.

For example, the composite may be modified with a C₆-C₃₀ aliphatic group including C₁₀-C₂₈ as well as C₁₂-C₂₅ aliphatic group. As used herein, “aliphatic group” means a saturated or unsaturated linear or branched hydrocarbon group. A hydrocarbon group refers broadly to a substituent comprising carbon and hydrogen, optionally with 1 to 3 heteroatoms, for example, oxygen, nitrogen, halogen, silicon, sulfur, or a combination thereof. An aliphatic group may be an alkyl, alkenyl, or alkynyl group, for example.

In another embodiment, the hydrophobic composite may be prepared by modifying the surface of the composite with a fatty acid. The fatty acid can be saturated or unsaturated. A mixture of different fatty acids can be used. Exemplary fatty acids include caprylic acid, capric acid, lauric acid, myristic acid, palmitic acid, stearic acid, behenic acid, lignoceric acid, cerotic acid, myristoleic acid, palmitoleic acid, sapienic acid, oleic acid, elaidic acid, vaccenic acid, linoleic acid, arachidonic acid, erucic acid, or a combination comprising at least one of the foregoing.

An exemplary process for preparing the hydrophobic composite may include dissolving the modifying agent having an aliphatic tail and a head in a solvent. The tail may contain the C₆-C₃₀ or C₁₂-C₂₅ aliphatic group. The head may contain a functional group such as a carboxylic acid group. The composite may then be introduced to the solution containing the modifying agent. The composite may in a powder form or, alternatively, may be first dissolved or dispersed in a solvent to form a solution or dispersion. After the modifying agent is combined with the composite in the presence of a solvent, the mixture may be mixed for a sufficient amount of time such that the head of the modifying agent bonded or attached to the surface of the composite.

In like manner, the composites may be rendered hydrophilic by reacting the surface of the composite with an alcohol.

In some embodiment, a modifying agent may be used which imparts both hydrophobic and oleophobic properties to the composite. For instance, the modifying agent may be an organo-silicon containing material or a fluorinated alkyl.

In an embodiment, the organo-silicon containing material may be a silane, polysiloxane or a polysilazane.

Examples of organo-silicon containing materials are those having the formula R¹₄₋ₓSiAₓ or (R¹₃Si)_{y}B as well as organo(poly)siloxanes and organo(poly)silazanes containing units of the formula:

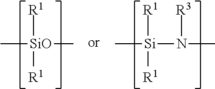

where R¹ may be the same or different and is a hydrocarbon radical containing from 1 to 100, such as 1 to 20 carbon atoms and 1 to 12, preferably 1 to 6 carbon atoms and R³ may be hydrogen or a hydrocarbon or substituted hydrocarbon having 1 to 12, preferably 1 to 6 carbon atoms. In addition, R¹ may be a substituted, hydrocarbon radical such as halo, particularly a fluoro-substituted hydrocarbon radical. The organo(poly)siloxane may further contain additional units of the formula: R⁵₂SiO₂ where R⁵ is a halogen such as a chloro or fluoro substituent.

In an embodiment, the organo-silicon containing compound may be an organo(poly)siloxane or organo(poly)silazane of a number average molecular weight of at least 400, usually between 1000 and 5,000,000.

The substituent A in R¹₄₋ₓSiAₓ may be hydrogen, a halogen such as chloride, OH, OR² or

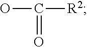

wherein B in the above structural formula may be NR³_{3-y}, R² a hydrocarbon or substituted hydrocarbon radical containing from 1 to 12, typically 1 to 4 carbon atoms. R³ is hydrogen or has the same meaning as R¹, x is 1, 2 or 3, y is 1 or 2.

In an embodiment, R¹ may be a fluoro-substituted hydrocarbon. Preferred as fluoro-substituted hydrocarbons are those of the structure:

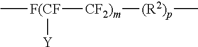

where Y is F or CₙF₂ₙ₊₁; m is 4 to 20 and n is 1 to 6; R² is alkyl containing from 1 to 4 carbon atoms and p is 0 to 18. Also, fluoro-substituted hydrocarbons may be of the structure:

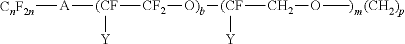

where A is an oxygen radical or a chemical bond; n is 1 to 6, y is F or CₙF₂ₙ; b is at least 1, such as 2 to 10; m is 0 to 6 and p is 0 to 18.

Preferred organo-silicon materials include halogenated siloxanes, halogenated alkoxysiloxanes such as perfluoroalkoxysiloxane (PFOSi), alkoxy halogenated alkoxysilanes, such as alkoxy-perfluoroalkoxysilane; alkoxyacetylacetonate halogenated polysiloxanes, such as alkoxyacetylacetonate-perfluoroalkoxysiloxane, alkoxy-alkylsilylhalides; polyalkylsiloxanes, such as polydimethylsiloxanes, and alkoxyacetylacetonate-polyalkylsiloxanes, such as alkoxyacetylacetonate (acac) polydimethylsiloxanes. Exemplary surface modifying treatment agents include tantalum halide-perfluoroalkoxysiloxane, such as TaCl₅:PFOSi; tantalum alkoxy-perfluoroalkoxysilane; tantalum alkoxyacetylacetonate-perfluoroalkoxysiloxane, like Ta(EtO)₄acac:PFOSi; tantalum alkoxy-alkylsilylhalide; tantalum halide-polyalkylsiloxane, like TaCl₅:PDMS; niobium alkoxide-perfluoroalkoxysiloxane, such as Nb(EtO)₅:PFOSi and Ta(EtO)₅:PFOSi; titanium alkoxide-perfluoroalkoxysiloxane, like Ti(n-BuO)₄:PFOSi; zirconium alkoxide-perfluoroalkoxysiloxane; lanthanum alkoxide-perfluoroalkoxysilane, like La(iPrO)₃:PFOSi; tungsten chloride-perfluoroalkoxysiloxane, like WCl₆:PFOSi; tantalum alkoxide-polyalkylsiloxane, like Ta(EtO)₅:PDMS; and tantalum alkoxyacetylacetonate-polyalkylsiloxane, like Ta(EtO)₄acac:PDMS.

In an embodiment, the fluorinated hydrocarbon is R_{f}—(CH₂)ₚ—X where R_{f} is a perfluorinated hydrocarbon group including an oxygen substituted hydrocarbon group, such as a perfluorinated alkyl group or a perfluorinated alkylene ether group and p is 0 to 18, preferably 0-4, and X is a polar group such as carboxyl, like of the structure —(C═O)—OR; and R is hydrogen, perfluoroalkyl, alkyl or substituted alkyl containing from 1 to 50 carbon atoms.

Examples of perfluoroalkyl groups are those of the structure F—(CFY—CF₂)ₘ where Y is F or CₙF₂ₙ₊₁; m is 4 to 20 and n is 1 to 6.

Examples of perfluoroalkylene ether groups are those of the structure:

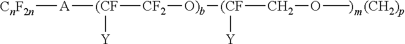

where A is an oxygen radical or a chemical bond; n is 1 to 6, Y is F or CₙF₂ₙ; b is 2 to 20, m is 0 to 6, and p is 0 to 18, preferably 2 to 4 and more preferably 2.

Preferred fluorinated materials are esters of perfluorinated alcohols such as the alcohols of the structure F—(CFY—CF₂)ₘ—CH₂—CH₂—OH where Y is F or CₙF₂ₙ₊₁; m is 4 to 20 and n is 1 to 6.

Further preferred as fluorinated hydrocarbons are perfluorinated hydrocarbons of the structure R_{f}—(CH₂)ₚ—X where R_{f} is a perfluoroalkylene ether group or a perfluorinated alkyl group such as those described above, p is an integer of from 0 to 18, preferably 0 to 4, and X is a carboxyl group, preferably a carboxylic ester group containing from 1 to 50, preferably from 2 to 20 carbon atoms in the alkyl group that is associated with the ester linkage.

Further preferred as fluorinated hydrocarbons are perfluorinated hydrocarbons of the structure R_{f}—(CH₂)ₚ—Z where R_{f} and p are as defined above, preferably R_{f} is a perfluoroalkylene ether group such as those described above, and p is from 2 to 4, and Z is a phosphorus acid group. Examples of phosphorus acid groups are:

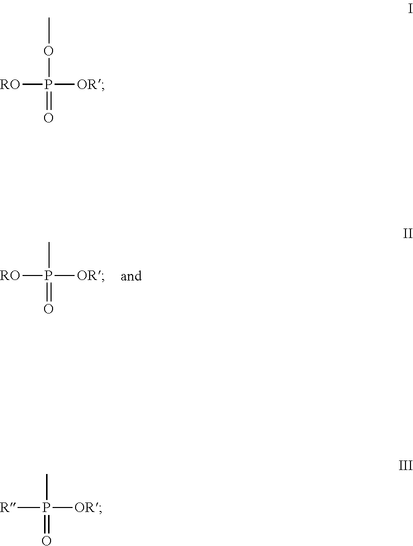

where R″ is a hydrocarbon or substituted hydrocarbon radical having up to 200, such as 1 to 30 and 6 to 20 carbons, R″ can also include the perfluoroalkyl groups mentioned above, and R′ is H, a metal such as potassium or sodium or an amine or an aliphatic radical, for example, alkyl including substituted alkyl having 1 to 50 carbons, preferably lower alkyl having 1 to 4 carbons such as methyl or ethyl, or aryl including substituted aryl having 6 to 50 carbons.

The composites may be employed with carrier or treatment fluids in order to facilitate placement of the composite to a desired location within the formation. The composites may be introduced into the wellbore at any concentration deemed suitable or effective for the downhole conditions to be encountered. The composite may be introduced as part of a treating fluid into a well down wellbore tubulars (e.g., tubing, workstring, casing, drill pipe) or down coiled tubing, for example at concentrations of about 0.25 to about 15 pounds per gallon of carrier fluid.

Any carrier fluid suitable for transporting the composite into a well and/or subterranean formation fracture in communication therewith may be employed including, but not limited to, carrier fluids including a completion or workover brine, salt water or brine, fresh water, potassium chloride solution, a saturated sodium chloride solution, liquid hydrocarbons or a gas or liquefied gas such as nitrogen or carbon dioxide.

The fluids may be gelled, non-gelled or have a reduced or lighter gelling requirement as compared to carrier fluids employed with conventional fracture treatment/sand control methods. The latter may be referred to as “weakly gelled”, i.e., having minimum sufficient polymer, thickening agent, such as a viscosifier, or friction reducer to achieve friction reduction when pumped downhole (e.g., when pumped down tubing, work string, casing, coiled tubing, drill pipe, etc.), and/or may be characterized as having a polymer or viscosifier concentration of from greater than 0 pounds of polymer per thousand gallons of base fluid to about 10 pounds of polymer per thousand gallons of base fluid, and/or as having a viscosity of from about 1 to about 10 centipoises. The non-gelled carrier fluid may contain no polymer or viscosifier.

The use of a non-gelled carrier fluid eliminates a source of potential proppant pack and/or formation damage and enhancement of well productivity. Elimination of the need to formulate a complex suspension gel may further mean a reduction in tubing friction pressures, particularly in coiled tubing and in the amount of on-location mixing equipment and/or mixing time requirements, as well as reduced costs.

The carrier or fracturing fluid may further contain one or more conventional additives to the well service industry such as a gelling agent, crosslinking agent, gel breaker, surfactant, biocide, surface tension reducing agent, foaming agent, defoaming agent, demulsifier, non-emulsifier, scale inhibitor, gas hydrate inhibitor, polymer specific enzyme breaker, oxidative breaker, buffer, clay stabilizer, acid, buffer, solvent or a mixture thereof and other well treatment additives known in the art. The addition of such additives to the carrier fluids minimizes the need for additional pumps required to add such materials on the fly.

Additives, such as fillers, plasticizers, cure accelerators and retarders, and rheology modifiers may be used in the coating compositions described herein in order to achieve desired economical, physical, and chemical properties of the proppant or sand control particulate coating during the mixing of the chemical components, forming and cure of the particles, and the field performance of the coatings on the proppant or sand control particulates.

Compatible fillers include, but are not necessarily limited to, waste materials such as silica sand, Kevlar fibers, fly ash, sludges, slags, waste paper, rice husks, saw dust, and the like, volcanic aggregates, such as expanded perlite, pumice, scoria, obsidian, and the like, minerals, such as diatomaceous earth, mica, borosilicates, clays, metal oxides, metal fluorides, and the like, plant and animal remains, such as sea shells, coral, hemp fibers, and the like, manufactured fillers, such as silica, mineral fibers and mats, chopped or woven fiberglass, metal wools, turnings, shavings, wollastonite, nanoclays, carbon nanotubes, carbon fibers and nanofibers, graphene oxide, or graphite. In some non-limiting instances these fillers maybe part of the reaction.

The composites have particular applicability in fracturing operations of low permeability subterranean reservoirs such as those comprised primarily of coal, limestone, dolomite, shale, siltstone, diatomite, etc., known to be susceptible to fines generation due to their friable nature.

When used in hydraulic fracturing, the composites are injected into the formation at pressures sufficiently high to cause the formation or enlargement of fractures, or to otherwise expose the composites to formation closure stress. The composites form a pack having voids in the fracture. The high conductivity of the created fractures is attributable to the ability of produced fluids to flow around the widely spaced composites instead of being confined to the relatively small interstitial spaces evidenced in the packed bed. Any closure of the formation between the composites that occurs within the fracture will be held open and remain conductive by the composites bracing the fracture walls apart. The diameter of the composite is substantially similar to the width of the created fracture to be created.

The composite may withstand a closure stress of at least about 1000 psi (6.9 MPa), alternatively of at least about 5000 psi (34 MPa) or greater, up to 10,000 psi (69 MPa), even without the coating. However, with the coatings described herein, compression strength may range up to about 12,000 psi (83 MPa), and even up to 130 MPa (18,900 psi). In one non-limiting embodiment, the compressive strength ranges from about 35 to about 130 MPa, alternatively from about 50 to about 100 MPa, and in another non-restrictive embodiment from about 60 to about 83 MPa. However, it will be understood with benefit of this disclosure that these are just optional guidelines.

Since the composites withstand high reservoir closure stresses, they prevent the full closure of the facture, thereby enhancing fracture conductivity. The composite exhibits enhanced conductivity of fractures compared to a pristine proppant. (The term “pristine” as used herein refers to the uncoated proppant or sand control particulate. When referencing a pristine proppant or sand control particulate, it is understood that the pristine proppant or sand control particulate is the same as the core of the composite.)

In an embodiment, the matrix or pack containing the composites has a conductivity equal to or greater than 800 millidarcy feet (mdft), 300 mdft, 90 mdft, 20 mdft and 10 mdft at a pressure of about 2000 psi, 4000 psi, 6000 psi, 8,000 and 10,000 psi, respectively, at a loading of 2 lbs/ft² and 150 F according to ISO 13503-5/API-RP-19D.

The strength of the composite further minimizes or prevents embedment of the composite into the rock at high stresses (typically in excess of 10,000 psi). Embedment of proppant into the formation decreases the width of the proppant pack. Embedment reduces proppant pack conductivity as the embedded proppant plugs pore throats of the pack with formation fines spalled from the rock displaced into the proppant pack. The reduction in fine generation thus enhances fracture conductivity.

In a preferred embodiment, the composites are deformable. By “deformable”, it is meant that the composites of the pack substantially yield upon application of a threshold level to point to point stress. The in situ deformation of the composites form multi-planar structures or networks and thus serve as a cushion to prevent grain-to-grain contact and absorb stress. Such cushioning prevents the composite from shattering or breaking due to stress (including stress induced by stress cycling). The deformability of the composites attributes to less fines being generated and conductivity being maintained. Reduction in fines generation further permits the extension of the closure stress range in which the proppant pack may be used.

The increased strength of the composites over the pristine proppant makes the composites particularly effective in reducing the generation of fines. Fines are typically generated at the fracture-face to proppant pack interface as in situ closure stresses acting upon the fracture cause failure of the proppant, the formation rock, or both. Such stresses cause particulates of proppant to be compressed together such that fines are generated from the proppant pack and/or reservoir matrix. Since the composites are capable of withstanding high closure stresses applied on the proppant pack, the generation of fines is reduced.

Fracture conductivity may be further increased by the placement of the composite to create a partial monolayer to support the fracture. Fractures containing partial monolayers exhibit vacant areas around and between the composites which thereby increases the relative conductivity of the propped fracture. The monolayer is created when the propped fracture has a width that is equal to one particle diameter with no remaining voids into which additional particles may be placed.

While the packing of a complete monolayer of composite is 2 pounds per square foot, the packing of a partial monolayer of the composite is typically between from about 0.02 to about 0.8 lbs. per sq. ft for the composite with ASG between 1.1 and 1.5. Such packing causes an increase in porosity of the fracture. The resulting partial monolayer of composite exhibits greater conductivity than that evidenced with the complete monolayer.

In one non-limiting embodiment, the composites may be useful for flow back control, particularly in the embodiment where the coating may be deformable—this may help the proppant stay in place. These materials may be used together with non-coated and pristine proppant particulates. It is expected that flowing fluid back through the composites where the amount of the proppants flowed back (in the composite) is less than the amount of otherwise pristine proppants flowed back. In one non-limiting version, the amount of proppants flowed back is reduced from about 10 wt % or more less proppant produced to 100 wt %; alternatively, the amount of proppants flowed back is reduced from about 20 wt % or more less proppant produced to 80 wt %.

In one non-limiting embodiment, the flexibility of the coating may be improved by including in the coating a hydratable polymer such as carboxyalkyl celluloses, like carboxymethyl cellulose and/or galactomannan gums, such as underivatized guar and/or guar derivatives and the like These polymers are included in the structure of the coating and thus not available to be solubilized in the fracturing fluid.

Further, the composites may be used in a sand control method (such as gravel packing) for a wellbore penetrating a subterranean formation and may be introduced into the wellbore in a slurry with a carrier fluid. A screen assembly such as is known in the art may be placed or otherwise disposed within the wellbore so that at least a portion of the screen assembly is disposed adjacent the subterranean formation. A slurry including the composite in the carrier fluid may then be introduced into the wellbore and placed adjacent the subterranean formation by circulation or other suitable method so as to form a fluid-permeable pack in an annular area between the exterior of the screen and the interior of the wellbore that is capable of reducing or substantially preventing the passage of formation particles from the subterranean formation into the wellbore during production of fluids from the formation, while at the same time allowing passage of formation fluids from the subterranean formation through the screen into the wellbore.

As an alternative to use of a screen, the sand control method may use the composite in accordance with any method in which a pack of particulate material is formed within a wellbore that it is permeable to fluids produced from a wellbore, such as oil, gas, or water, but that substantially prevents or reduces production of formation materials, such as formation sand, from the formation into the wellbore. Such methods may or may not employ a gravel pack screen, may be introduced into a wellbore at pressures below, at or above the fracturing pressure of the formation, such as frac pack, and/or may be employed in conjunction with resins such as sand consolidation resins if so desired.

The composites may be employed to simplify hydraulic fracturing treatments or sand control treatments performed through coil tubing, by greatly reducing fluid suspension property requirements. When placed downhole, the composite exhibits a much reduced propensity to settle (as compared to conventional proppant or sand control particulates), particularly in highly deviated or horizontal wellbore sections.

In this regard, the composites may be advantageously employed in any deviated well having an angle of deviation of between about 0° and about 90° with respect to the vertical. However, in one embodiment, the composite may be advantageously employed in horizontal wells, or in deviated wells having an angle with respect to the vertical of between about 30° and about 90°, alternatively between about 75° and about 90°.

The composite may further be utilized as particulate/proppant material at more severe or demanding downhole conditions (e.g., at higher downhole temperatures and/or under higher downhole conditions of closure stress) than the conditions under which conventional particulates are suitably employed. The downhole temperatures may be greater than or equal to about 300° F.

The composites defined herein further exhibit a variety of features, some of which have already been mentioned.
The composites reach their final mechanical properties by chemical reaction at low temperature (<575° F.).
Bonding type of the composites include a mixture of ionic, covalent and Van Der Waals bonding, with the ionic and covalent dominating.
Both density and compressive strength can be controlled with additives and processing.
The composites are thermally stable, which means that they do not decompose or come apart at high temperatures, even up to at least 1470° F. In one non-limiting embodiment the high temperature range may be from about 40° F. to about 600° F.

FIG. 1 illustrates a schematic, cross-sectional diagram of a coated proppant or sand control particulate 10 as described herein, where the proppant or sand control particulate core 12 is at least partially coated by a coating 14.

### EXAMPLES

Crush resistant tests were performed according to the procedure detailed in API-RP-19C. The proppant materials were crushed at 6, 7, 8, 10 and 12 kpsi. 41.15 g of sieved, split proppant were loaded in the crush cell and crushed at a given stress level using an MTS hydraulic press (Model 561-324-01, with a capacity of 550 kpsi). The stress was increase at a rate of 2,000 psi/min. Once the desired stress was reached, the sample was maintained at stress for 2 min before release. The sample was then removed from the cell and sieved for 10 min using the stack of sieves where the initial particles fell in size. Finally, the crushed particles were weighed out. The particles that fell below the lowest mesh size of the stack were considered “fines.” For example for 20/40 mesh sand, any particles that fell below 40 mesh were considered fines. The % crush mass was determined using equation (2).

$${m}_{pan}^{′} = \frac{{m}_{pan}}{{m}_{s}} \times 100 \qquad ( 2 )$$

where:

m′ₚₐₙ is the mass of fines generated in the test, in g;

mₛ is the mass of proppant recovered from the cell, expressed in g

### Example 1

Magnesium potassium phosphate hydrate (MKP), which may be synthesized according to the following reaction:

MgO+KH₂PO₄+5H₂O→MgKPO₄.6H₂O

This is an exothermic reaction. The resulting MKP is a hard, very durable solid phase with very low aqueous solubility. It is a highly crystalline material and has a density of 1.84 g/cm³, and is thermally stable.

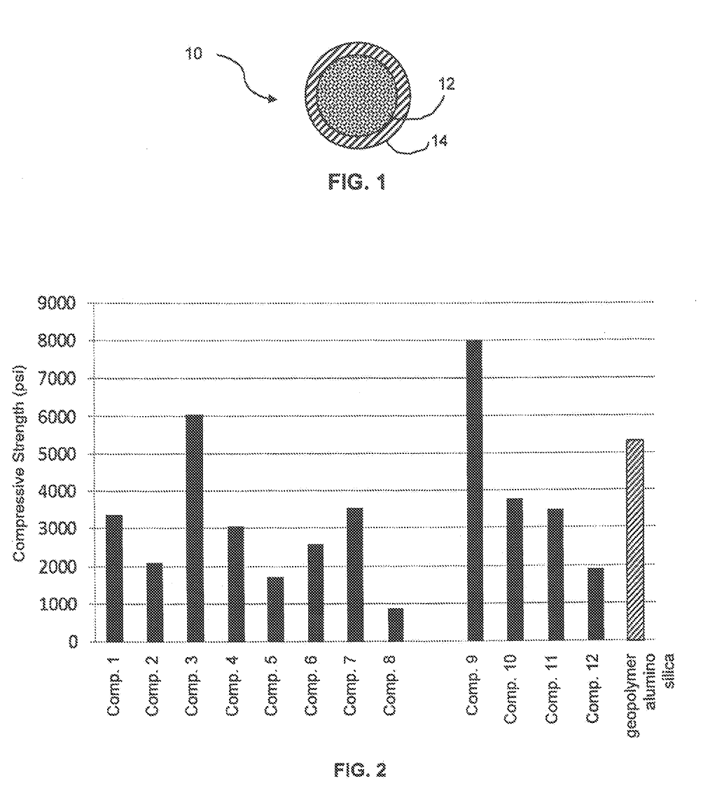

Table I presents the compositions 1-11 which are MKP, but differ by which filler is used. “Comp.” is an abbreviation for “composition”, not comparative. FIG. 2 is a chart of compressive strength for various MPK compositions in accordance with the methods described herein and as compared to the geopolymer alumino silica mentioned previously.

TABLE I

| | | Compressive | |
|---|---|---|---|
| Comp. | Filler | Strength (psi) | Density (g/cm³) |
| 1 | Fly Ash Class C | 3366 | 2 |
| 2 | Fly Ash Class F | 2097 | 2 |
| 3 | Wollastonite | 6049 | 2.2 |
| 4 | Pumice | 3053 | 1.92 |
| 5 | Fly Ash Class C | 1706 | 1.94 |
| 6 | Fly Ash Class F | 2575 | 1.77 |
| 7 | Wollastonite | 3535 | 1.91 |
| 8 | Pumice | 877 | 1.55 |
| 9 | Fly Ash Class C | 7986 | |
| 10 | Fly Ash Class F | 3768 | |
| 11 | Wollastonite | 3469 | |
| 12 | Pumice | 1910 | |

Further, presented in Table II is a comparison of the weight percent fines generated (based on total proppant present) for MPK coated sand when a specific stress is applied for a sample of approximately 40 g for control 30/50 sand without a MKP coating and fines generated for 30/50 sand with a MKP coating demonstrating that much less fines are generated with the coated sand.

TABLE II

| | Control Sand 30/50 | Coated 30/50 Sand |
|---|---|---|
| | Wt % fines generated | Wt % fines generated at |
| Stress, psi (MPa) | at applied stress | applied stress |
| 6,000 (41.4) | 14.8 | 10.3 |
| 7,000 (48.2) | 20.6 | 12.5 |
| 8,000 (55.2) | 25.7 | 14.7 |

### Examples 2-4

Silica sand proppant of 40/70 mesh and having a crush resistance (API-RP-19C) rating of 5 k was pre-heated in an oven and then transferred to a laboratory mixer. To the mixer was added uncompacted silica fume, dehydroxylated kaolin (prepared by calcining kaolin at 1380° F. for two hours) and 12M potassium hydroxide. Mixing continued as a sol-gel exothermic reaction occurred between the silica and aluminosilicate to provide the polymerized aluminosilicate coating. The coated sand then removed from the mixer and heat cured in an oven.

The crush resistance of the composite at 8,000 psi and 11,000 psi stresses was obtained using API-RP-19C standardized testing procedures and the wt. percent fines determined. The results are shown in Table III:

TABLE III

| | Ex. Nos. | | |
|---|---|---|---|
| | 2 | 3 | 4 |
| n[SiO₂]/[Al₂O₃] | 2.83 | 3.6 | 4.13 |
| Silica Fume, g | 17.45 | 45.00 | 45.00 |
| Dehydroxylated | 7.005 | 100.00 | 75.00 |
| kaolin, g | | | |
| Fines (wt. %) @ | 12.60% | 13.10% | 11.30% |
| 8000 psi | | | |
| Fines (wt. %) @ | 36.50% | 22.10% | 16.40% |
| 11,000 psi | | | |

Table III illustrates the effect of the molar ratio of silica:aluminum on the weight percent fines. As illustrated, an increase in the molar ratio reduced the amount of fines at closure stresses of 8,000 psi as well as 11,000 psi. Table III also demonstrates the effect of the molar ratio on the bonding strength between the sand the aluminosilicate coating; for example, the bonding strength of Ex. No. 3 being greater than the bonding strength of Ex. No. 2 as evidenced by the lower amount of fines at higher closure stresses.

### Example 5

Shown in FIG. 3B is a microphotograph of white sand proppant as a control. Shown in FIG. 3A is the white sand proppant of FIG. 3B after having been coated with 5 wt % of an aluminosilicate coating as described herein.

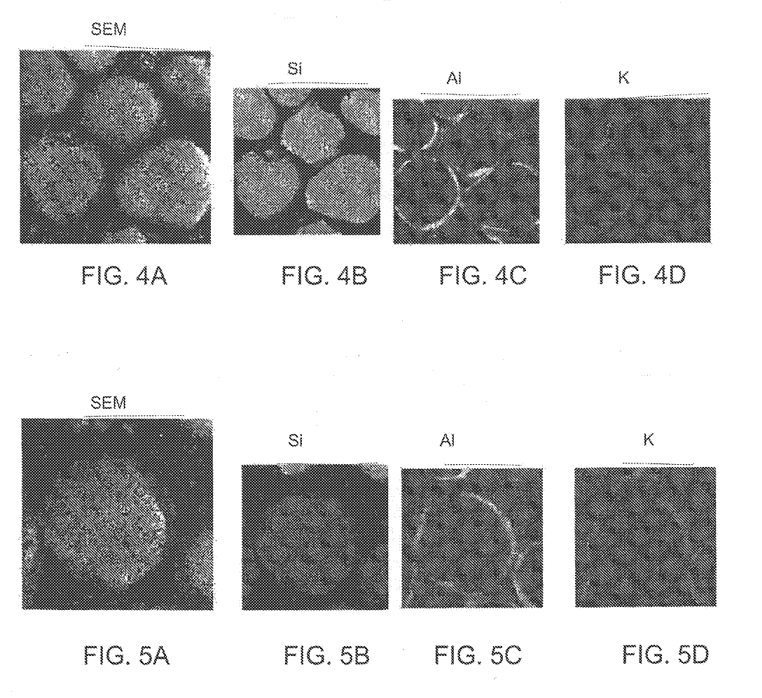

The coating on the white sand proppant was characterized by SEM (scanning electron microscopy, FEI XL-30) as shown in FIGS. 4A-5D. The micrographs (microphotographs) of FIGS. 4A-4D were taken at 50× magnification and FIGS. 5A-5D were taken at 80× magnification. FIGS. 4A and 5A were obtained from secondary electrons that produce SEM images. Since the coating is an aluminosilicate and the core is silica sand, there is no differentiation between the two materials through direct observation by SEM, the geopolymer coating cannot be seen directly from the SEM micrographs of FIGS. 4A and 5A. Backscatter electron (BSE) images can provide information about the distribution of different elements in the sample. Silicon, aluminum and potassium profiles of the coating are shown by the back scattering micrographs of FIGS. 4B and 5B, FIGS. 4C and 5C and FIGS. 4D and 5D, respectively. The SEM micrographs in FIGS. 4A and 5A show that the particles are homogeneous, FIGS. 4B and 5B, FIGS. 4C and 5C and FIGS. 4D and 5D show that the coating is evenly distributed around the surface of the core.

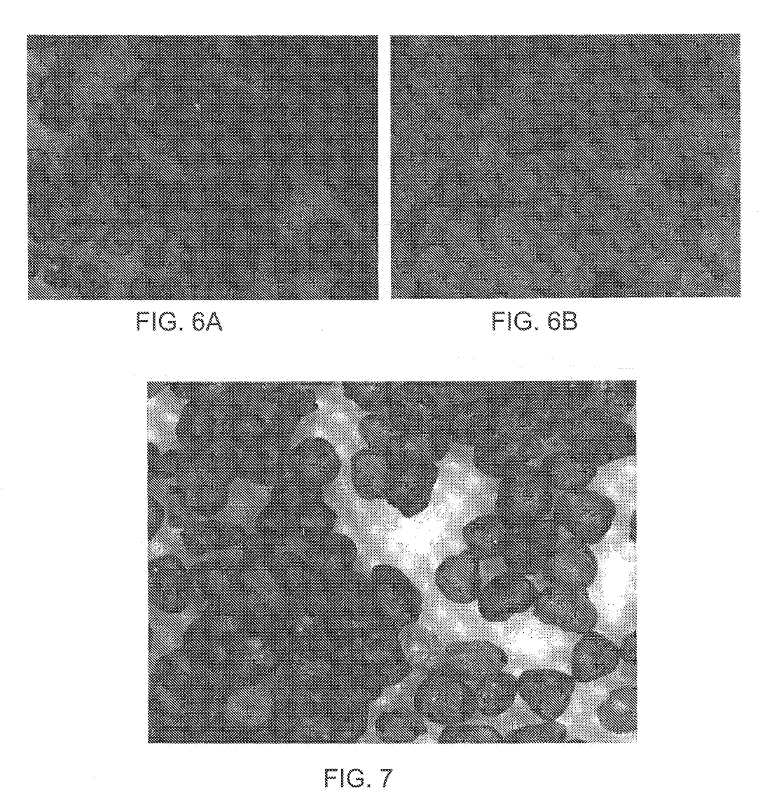

Shown in FIG. 6B is a micrograph of brown sand as a control proppant with no coating. This is contrasted with FIG. 6A which is a micrograph of brown sand, such as that seen in FIG. 6B, having an 8 wt % coating of aluminosilicate as described herein; which coated proppant is designated III-30.

Shown in FIG. 7 is a micrograph of brown sand having a 15 wt % aluminosilicate coating thereon, designated as III-31.

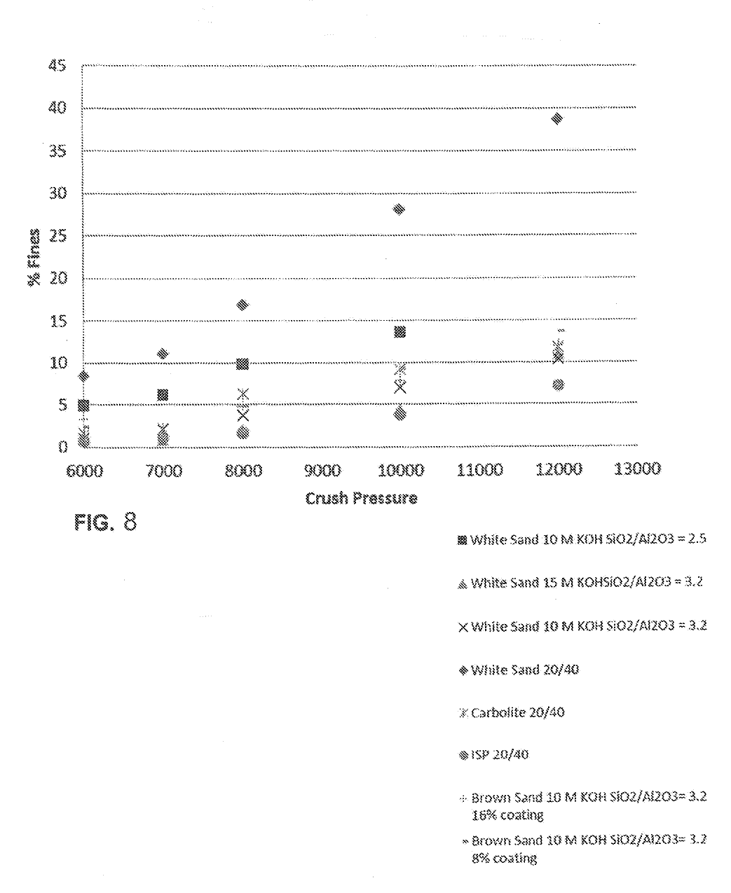

Shown in FIG. 8 is a graph illustrating the wt % generated fines as a function of closure stress of some geopolymer-coated sand compared to some conventional proppants. A more specific description of the various proppants of FIG. 8, in the order of the legend in FIG. 8 is as follows:
▪ White sand coated with a solution of 10 M potassium hydroxide (KOH) and SiO₂/Al₂O₃ at a molar ratio of 2.5:1.
▴ White sand coated with a solution of 15 M KOH and SiO₂/Al₂O₃ at a molar ratio of 3.2:1.
X White sand coated with a solution of 10 M KOH and SiO₂/Al₂O₃ at a molar ratio of 3.2:1.
♦ White sand 20/40 mesh (0.8/0.4 mm).
[symbol] CARBOLITE® 20/40 mesh (0.8/0.4 mm) proppant available from Carbo Ceramics.
● ISP 20/40 mesh (0.8/0.4 mm) proppant available from Carbo Ceramics.
+ Brown sand coated with a solution of 10 M KOH and SiO₂/Al₂O₃ at a molar ratio of 3.2:1 with a 16 wt % coating.
− Brown sand coated with a solution of 10 M KOH and SiO₂/Al₂O₃ at a molar ratio of 3.2:1 with an 8 wt % coating.

It may be seen from FIG. 8 that the coated proppants as described herein have reduced fines production compared to some commonly used commercial proppants.

### Examples 6-8

Silica sand proppant having particles size of 40/70 mesh and having a crush resistance (API 56/58/60) rating of 5,000 psi was pre-heated in an oven and then transferred to a laboratory mixer. To the mixer was added an initial uncompacted silica fume (initial silica), dehydroxylated kaolin (prepared by calcining kaolin at 1380° F. for two hours) and 12M potassium hydroxide. Hardening of the kaolin and silica fume began during the mixing. While hardening, 19 ml of a diluted aqueous spray containing 25 vol. percent sodium silicate was applied over 30 minutes. A sol-gel exothermic reaction occurred between the silica, dehydroxylated kaolin and sodium silicate. The coated sand then removed from the mixer and cured at 572° F. in an oven. The resulting composite was then subjected to closure stresses of 8,000 and 11,000 psi. The results are shown in Table IV:

TABLE IV

| | Ex. No. | | |
|---|---|---|---|
| | 6 | 7 | 8 |
| sand type/temp | 5K 40/70 @ | 5K 40/70 @ | 5K 40/70 @ |
| | 300 F. | 300 F. | 300 F. |
| Initial silica (g) | 17.45 | 45.0 | 45.0 |
| n[SiO₂]/Al₂O₃] | 2.83 | 3.6 | 4.13 |
| NaOH (g) | 6.92 | 6.92 | 6.92 |
| Na₂SiO₃ (g) | 37.68 | 37.68 | 37.68 |
| Water (g) | 3.00 | 3.00 | 3.00 |
| Dehydroxylated kaolin | 29.60 | 29.6 | 29.6 |
| (g) | | | |
| pH | 10.28 | 10.18 | 10.18 |
| Fines (wt. %) @ 8,000 psi | 6.16 | 7.97 | 7.21 |
| Curing time | 72 hours | 18 hrs | 18 hrs |

The results for wt. % fines illustrate the coated proppant as having met a crush resistance API rating of 8,000 psi.

### Example 9

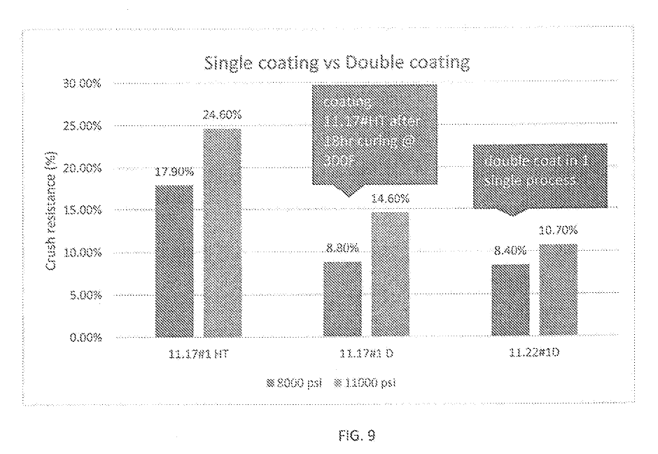

This Example demonstrates the effect of thickness on the final strength of the composite. Sample 12 was heat treated for 18 hours at 300° F. (11.17#HT) to provide a cured coating onto the sand core. To portions of the sample, a second aluminosilicate coating was then allowed to form by heating 11.17# (HT for 18 hours at 300° F. (11.17#1 D) and 1300° F. (11.22#1D), respectively. The results are illustrated in FIG. 9 and show that the amount of fines were decreased 50 percent at 8,000 psi and by 40% percent at 11,000 psi compared to the starting material (11.17#1HT). Having two layers of geopolymer coating dramatically improved the strength of the sand. Sample 11.22#1D exhibited better crush results at both 8,000 and 11,000 psi. At 12,000 psi 11.22#1D had 10.70% fines (representing sand having an API standard at 10,000 psi). The strength of the sand was thus increased from an API standard rating of 5,000 psi to 10,000 psi.

It will be appreciated that the descriptions above with respect to particular embodiments above are not intended to limit the invention in any way, but which are simply to further highlight or illustrate the invention.

It is to be understood that the invention is not limited to the exact details of procedures, operation, exact materials, or embodiments shown and described, as modifications and equivalents will be apparent to one skilled in the art. Accordingly, the invention is therefore to be limited only by the spirit and scope of the appended claims. Further, the specification is to be regarded in an illustrative rather than a restrictive sense. For example, specific combinations of proppant or sand control particulates, coatings, reactants to form the coatings and/or cores, reaction conditions to form coatings on the proppants, hydraulic fracturing method steps, and the like, falling within the claimed parameters, but not specifically identified or tried in a particular method, are anticipated to be within the scope of this invention.

The present invention may in one non-limiting embodiment comprise, alternatively consist or in a different non-restrictive version consist essentially of the elements disclosed.

While exemplary embodiments of the disclosure have been shown and described, many variations, modifications and/or changes of the system, apparatus and methods of the present disclosure, such as in the components, details of construction and operation, arrangement of parts and/or methods of use, are possible, contemplated by the patent applicant(s), within the scope of the appended claims, and may be made and used by one of ordinary skill in the art without departing from the spirit or teachings of the disclosure and scope of appended claims. Thus, all matter herein set forth or shown in the accompanying drawings should be interpreted as illustrative, and the scope of the disclosure and the appended claims should not be limited to the embodiments described and shown herein.

### Embodiment 1

A method of increasing the conductivity of a fracture in a subterranean formation comprising the steps of (a) providing a fracturing treatment fluid comprising a composite having a core selected from the group consisting of sand, ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles, and combinations thereof; and a coating at least partially covering the core, the coating being selected from the group consisting of aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK), and combinations thereof; (b) introducing particulates of the composite to the fracture; and (c) allowing the particulates to form a pack of composites having voids in the fracture.

### Embodiment 2

The method of Embodiment 1, wherein the proppant pack has a conductivity equal to or greater than 800 mdft at a pressure of about 2000 psi.

### Embodiment 3

The method of Embodiment 1, wherein the proppant pack has a conductivity equal to or greater than 300 mdft at a pressure of about 4000 psi.

### Embodiment 4

The method of Embodiment 1, wherein the proppant pack has a conductivity equal to or greater than 90 mdft at a pressure of about 6000 psi.

### Embodiment 5

The method of Embodiment 1, wherein the proppant pack has a conductivity equal to or greater than 20 mdft at a pressure of about 8000 psi.

### Embodiment 6

The method of Embodiment 1, wherein the proppant pack has a conductivity equal to or greater than 10 mdft at a pressure of about 10000 psi.

### Embodiment 7

A method of fracturing a subterranean formation penetrated by a well, the method comprising (a) pumping into the well at a pressure sufficient to enlarge or create a fracture a fluid comprising a composite having a core selected from the group consisting of sand, ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles, and combinations thereof; and a coating at least partially covering the core, the coating being selected from the group consisting of aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK), and combinations thereof; (b) propping open the fracture with the composite, wherein the composite is capable of withstanding a closure stress up to about 8,000 psi; and (c) producing hydrocarbons from the created or enlarged fracture.

### Embodiment 8

A sand control method for a wellbore penetrating a subterranean formation, comprising (a) introducing into the wellbore a slurry of a composite and a carrier fluid, wherein the composite comprises a sand control particulate having a core selected from the group consisting of sand, ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles, and combinations thereof; and a coating at least partially covering the core, the coating selected from the group consisting of aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK), and combinations thereof; (b) placing the composite adjacent the subterranean formation to form a fluid-permeable pack capable of reducing or substantially preventing the passage of formation particles from the subterranean formation into the wellbore while allowing passage of formation fluids from the subterranean formation into the wellbore, wherein the composite exhibits crush resistance under conditions greater than 8,000 psi closure stress.

### Embodiment 9

The method of Embodiment 7 or 8, wherein the composite exhibits crush resistance under conditions greater than 10,000 psi closure stress.

### Embodiment 10

The method of Embodiment 9, wherein the composite exhibits crush resistance under conditions greater than 12,000 psi closure stress.

### Embodiment 11

The method of Embodiment 10, wherein the composite exhibits crush resistance under conditions greater than 14,000 psi closure stress.

### Embodiment 12

A method of reducing the amount of fines generated during a hydraulic fracturing operation or a sand control operation on a subterranean formation, the method pumping a proppant or sand control particulate comprising a core selected from the group consisting of sand, ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles, and combinations thereof; and a coating at least partially covering the core, the coating being selected from the group consisting of aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK), and combinations thereof, wherein the amount of fines generated during pumping of the proppant or sand control particulate into the well is less than the amount of fines generated during pumping of the pristine proppant or sand control particulate not containing the coating into the well.

### Embodiment 13

The method of any of Embodiments 1 to 12, wherein the coating ranges from about 0.5 to about 30 wt % of the weight of the core.

### Embodiment 14

The method of Embodiment 13, wherein the coating ranges from about 0.5 to about 15 wt % of the weight of the core.

### Embodiment 15

The method of Embodiment 14, wherein the coating ranges from about 1 to about 8 wt % of the weight of the core.

### Embodiment 16

The method of any of Embodiments 13 to 15, wherein the composite withstands a closure stress up to about 8,000 psi when the coating ranges from about 5 to about 9 wt. percent of the weight of the core.

### Embodiment 17

The method of any of Embodiments 13 to 15, wherein the composite withstands a closure stress up to about 10,000 psi when the coating ranges from about 1 to about 15 wt. percent of the weight of the core.

### Embodiment 18

The method of any of Embodiments 13 to 15, wherein the composite withstands a closure stress up to about 12,000 psi when the coating ranges from about 1 to about 10 wt. percent of the weight of the core.

### Embodiment 19

The method of any of Embodiments 1 to 18, wherein the apparent density of the core is greater than or equal to 2.5 g/cc.

### Embodiment 20

The method of Embodiment 19, wherein the apparent density of the core is greater than or equal to 2.65 g/cc.

### Embodiment 21

The method of any of Embodiments 1 to 18, wherein the apparent density of the core is less than or equal to 2.25 g/cc.

### Embodiment 22

The method of Embodiment 21, wherein the apparent density of the core is less than or equal to 2.0 g/cc.

### Embodiment 23

The method of Embodiment 22, wherein the apparent density of the core is less than or equal to 1.75 g/cc.

### Embodiment 24

The method of Embodiment 23, wherein the apparent density of the core is less than or equal to 1.5 g/cc.

### Embodiment 25

The method of Embodiment 23, wherein the apparent density of the core is less than or equal to 1.25 g/cc.

### Embodiment 26

The method of any of Embodiments 1 to 25, wherein the apparent density of the composite is less than the apparent density of the core.

### Embodiment 27

The method of any of Embodiments 1 to 26, wherein the Krumbein sphericity of the composite is at least 0.5, API-RP-19C, and the roundness of the composite is at least 0.5 (on the Sloss Chart).

### Embodiment 28

The method of Embodiment 27, wherein the Krumbein sphericity of the composite is at least 0.6 and the roundness of the composite is at least 0.6 (on the Sloss Chart).

### Embodiment 29

The method of any of Embodiments 1 to 28, wherein the coating is heated prior to applying the coating to the core.

### Embodiment 30

The method of Embodiment 29, wherein the coating is subjected to polymerization at a temperature between 32° F. to about 575° F.

### Embodiment 31

The method of any of Embodiments 1 to 28, wherein the core is heated prior to applying the coating onto the surface of the core.

### Embodiment 32

The method of any of Embodiments 1 to 28, wherein the temperature of the core when the coating is applied to the core is between 0 to about 300° C.

### Embodiment 33

The method any of Embodiments 1 to 28, wherein the core and the coating are mixed in a pre-heated reactor.

### Embodiment 34

The method of any of Embodiments 1 to 33, wherein the surface of the composite is hydrophobic or oleophobic.

### Embodiment 35

The method of any of Embodiments 1 to 33, further comprising, prior to introducing particulates of the composite into a fracture, treating the surface of the composite with a surface modifying treatment agent to render the composite hydrophobic and/or oleophobic.

### Embodiment 36

The method of any of Embodiments 1 to 35, wherein the core is sand.

### Embodiment 37

The method of any of Embodiments 1 to 35, wherein the core is a member selected from the group consisting of ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles, and combinations thereof.

### Embodiment 38

The method of any of Embodiments 1 to 37, where the composite further comprises one or more fillers selected from the group consisting of silica sand, Kevlar fibers, fly ash, sludges, slags, waste paper, rice husks, saw dust, volcanic aggregates, expanded perlite, pumice, scoria, obsidian, minerals, diatomaceous earth, mica, borosilicates, clays, metal oxides, metal fluorides, plant and animal remains, sea shells, coral, hemp fibers, manufactured fillers, silica, mineral fibers, mineral mats, chopped fiberglass, woven fiberglass, metal wools, turnings, shavings, wollastonite, nanoclays, carbon nanotubes, carbon fibers and nanofibers, graphene oxide, graphite, and combinations thereof.

### Embodiment 39

The method of any of Embodiments 1 to 38, wherein the surface of the core is etched with alkali hydroxide prior to contacting the core with the coating.

### Embodiment 40

The method of any of Embodiments 1 to 39, wherein the coating is a geopolymer of aluminosilicate.

### Embodiment 41

The method of Embodiment 40, wherein the geopolymer is prepared from an alkali oxide, silicate and an aluminosilicate binder.

### Embodiment 42

The method of Embodiment 40 or 41, wherein the molar ratio of SiO₂:Al₂O₃ in the aluminosilicate is from about 1:1 to about 30:1.

### Embodiment 43

The method of Embodiment 42, wherein the molar ratio of SiO₂:Al₂O₃ in the aluminosilicate is from about 1:1 to about 6:1.

### Embodiment 44

The method of any of Embodiments 40 to 43, wherein the coating is prepared by mixing an alkali hydroxide/silicate aqueous solution with an aluminosilicate binder, applying the mixture onto the core and hardening the mixture on the core by a sol-gel reaction.

### Embodiment 45

The method of any of Embodiments 40 to 43, wherein the alkali hydroxide/silicate aqueous solution is sprayed onto the aluminosilicate binder to form the coating.

### Embodiment 46

The method of any of Embodiments 40 to 43, wherein the composite is prepared by forming a slurry of the alkali hydroxide, silicate and aluminosilicate binder and applying the slurry onto the core and then hardening the mixture on the core by a sol-gel reaction.

### Embodiment 47

The method of any of Embodiments 40 to 46, wherein the surface of the core is etched with alkali hydroxide prior to contacting the core with the aluminosilicate.

### Embodiment 48

The method of any of Embodiments 40 to 47, wherein the aluminosilicate coating is formed by initiating polymerization of the silicate and aluminosilicate binder by heating.

### Embodiment 49

The method of any of Embodiments 40 to 47, wherein the aluminosilicate coating is formed by initiating polymerization of the silicate and aluminosilicate at a temperature between about 65° F. and about 575° F.

### Embodiment 50

The method of any of Embodiments 1 to 39, wherein the coating is magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK), or a combination thereof.

### Embodiment 51

The method of any of Embodiments 1 to 39, wherein the coating is prepared from an alkali metal phosphate, phosphoric acid, ammonium phosphate, ammonium dihydrogen phosphate or a combination thereof and a binder.

### Embodiment 52

The method of any of Embodiments 1 to 39, wherein the coating is magnesium phosphate, calcium phosphate, aluminum phosphate, zirconium aluminum phosphate, zirconium phosphate, zirconium phosphonate, magnesium potassium phosphate, potassium aluminum phosphate, alkali metal transition metal phosphates, carbide materials, tungsten carbide, cements, polymer cements, polyamide-imides, polyether ether ketones (PEEK) or a combination thereof.

Although the foregoing description contains many specifics, these are not to be construed as limiting the scope of the disclosure, but merely as providing certain embodiments. Similarly, other embodiments may be devised that do not depart from the scope of the disclosure. For example, features described herein with reference to one embodiment also may be provided in others of the embodiments described herein. The scope of the disclosure is, therefore, indicated and limited only by the appended claims and their legal equivalents, rather than by the foregoing description. All additions, deletions, and modifications to embodiments of the disclosure, as described and illustrated herein, which fall within the meaning and scope of the claims, are encompassed by the disclosure.

What is claimed is:

1. A method of increasing the conductivity of a fracture in a subterranean formation comprising the steps of:
(a) providing a fracturing treatment fluid comprising a composite having a core selected from the group consisting of sand, ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles, and combinations thereof; and a coating at least partially covering the core, the coating being selected from the group consisting of aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK), and combinations thereof;
(b) introducing particulates of the composite to the fracture; and
(c) allowing the particulates to form a pack of composites having voids in the fracture.

2. The method of claim 1, wherein the proppant pack has a conductivity equal to or greater than 20 mdft at a pressure of about 8,000 psi.

3. The method of claim 1, wherein the proppant pack has a conductivity equal to or greater than 10 mdft at a pressure of about 10,000 psi.

4. The method of claim 1, wherein the apparent density of the composite is less than the apparent density of the core.

5. The method of claim 1, wherein the Krumbein sphericity of the composite is at least 0.6 and the roundness of the composite is at least 0.6 (on the Sloss Chart).

6. The method of claim 1, wherein further comprising, prior to introducing particulates of the composite into the fracture, treating the surface of the composite with a surface modifying treatment agent to render the composite hydrophobic or oleophobic.

7. The method of claim 1, wherein the surface of the core is etched with alkali hydroxide prior to contacting the core with the coating.

8. A method of reducing the amount of fines generated during a hydraulic fracturing operation or a sand control operation on a subterranean formation, the method pumping a proppant or sand control particulate comprising a core selected from the group consisting of sand, ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles, and combinations thereof; and a coating at least partially covering the core, the coating being selected from the group consisting of aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK), and combinations thereof, wherein the amount of fines generated during pumping of the proppant or sand control particulate into the well is less than the amount of fines generated during pumping of the pristine proppant or sand control particulate not containing the coating into the well.

9. The method of claim 8, wherein the composite withstands a closure stress up to about 10,000 psi when the coating ranges from about 1 to about 15 wt. percent of the weight of the core.

10. The method of claim 8, wherein the composite withstands a closure stress up to about 12,000 psi when the coating ranges from about 3 to about 20 wt. percent of the weight of the core.

11. The method of claim 8, wherein the apparent density of the core is greater than or equal to 2.65 g/cc.

12. The method of claim 8, wherein the apparent density of the core is less than 2.65 g/cc.

13. The method of claim 8, wherein the apparent density of the composite is less than the apparent density of the core.

14. The method of claim 8, wherein the Krumbein sphericity of the composite is at least 0.6 and the roundness of the composite is at least 0.6 (on the Sloss Chart).

15. The method of claim 8, wherein one of the following conditions is true:
(a) the coating is heated prior to applying the coating to the core;
(b) the coating is subjected to polymerization at a temperature between 32° F. to about 575° F.;
(c) the core is heated prior to applying the coating onto the surface of the core;
(d) the temperature of the core when the coating is applied to the core is between 32° F. to about 575° F.; or
(e) the core and the coating are mixed in a pre-heated reactor.

16. The method of claim 8, further comprising, prior to pumping the proppant or sand control particulate into the subterranean formation, treating the surface of the composite with a surface modifying treatment agent to render the composite hydrophobic or oleophobic.

17. The method of claim 8, wherein the core is sand.

18. The method of claim 8, wherein the core is a member selected from the group consisting of ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles, and combinations thereof.

19. The method of claim 8, wherein the surface of the core is etched with an alkali hydroxide prior to contacting the core with the coating.

20. The method of claim 8, wherein the coating is a geopolymer of aluminosilicate.

21. The method of claim 20, wherein the molar ratio of SiO₂:Al₂O₃ in the aluminosilicate is from about 1:1 to about 30:1.

22. The method of claim 8, wherein one of the following is true:
(a) the coating is prepared by mixing an alkali hydroxide/silicate aqueous solution with an aluminosilicate binder, applying the mixture onto the core and hardening the mixture on the core by a sol-gel reaction;
(b) the alkali hydroxide/silicate aqueous solution is sprayed onto the aluminosilicate binder to form the coating;
(c) the composite is prepared by forming a slurry of the alkali hydroxide, silicate and aluminosilicate binder and applying the slurry onto the core and then hardening the mixture on the core by a sol-gel reaction.
(d) the aluminosilicate coating is formed by initiating polymerization of the silicate and aluminosilicate at a temperature between about 65° F. and about 575° F.; or
(e) the coating is magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK), or a combination thereof.

23. The method of claim 8, where the coating further comprises one or more fillers selected from the group consisting of silica sand, Kevlar fibers, fly ash, sludges, slags, waste paper, rice husks, saw dust, volcanic aggregates, expanded perlite, pumice, scoria, obsidian, minerals, diatomaceous earth, mica, borosilicates, clays, metal oxides, metal fluorides, plant and animal remains, sea shells, coral, hemp fibers, manufactured fillers, silica, mineral fibers, mineral mats, chopped fiberglass, woven fiberglass, metal wools, turnings, shavings, wollastonite, nanoclays, carbon nanotubes, carbon fibers and nanofibers, graphene oxide, graphite, and combinations thereof.

24. A sand control method for a wellbore penetrating a subterranean formation, comprising:
introducing into the wellbore a slurry of a composite and a carrier fluid, wherein the composite comprises a sand control particulate having a core selected from the group consisting of sand, ceramic beads, glass beads, bauxite grains, sintered bauxite, sized calcium carbonate, walnut shell fragments, aluminum pellets, nylon pellets, nut shells, gravel, resinous particles, alumina, minerals, polymeric particles, and combinations thereof; and a coating at least partially covering the core, the coating selected from the group consisting of aluminosilicate, magnesium phosphate, aluminum phosphate, zirconium aluminum phosphate, zirconium phosphate, zirconium phosphonate, magnesium potassium phosphate, carbide materials, tungsten carbide, polymer cements, high performance polymer coatings, polyamide-imides, polyether ether ketones (PEEK), and combinations thereof;
placing the composite adjacent the subterranean formation to form a fluid-permeable pack capable of reducing or substantially preventing the passage of formation particles from the subterranean formation into the wellbore while allowing passage of formation fluids from the subterranean formation into the wellbore
wherein the composite exhibits crush resistance under conditions greater than 8,000 psi closure stress.
